(19) United States
(12) Patent Application Publication
(10) Pub. No.: US 2009/0126119 A1
(43) Pub. Date: May 21, 2009

(54) FIRE RESISTANT INSULATOR PAD

(75) Inventor: Steven E. OGLE, Cary, NC (US)

Correspondence Address: CONLEY ROSE, P.C., 5601 GRANITE PARKWAY, SUITE 750, PLANO, TX, 75024, US

(73) Assignee: L&P Property Management Company, a Delaware corporation, South Gate, CA (US)

(21) Appl. No.: 12/101,811

(22) Filed: Apr. 11, 2008

Related U.S. Application Data
(63) Continuation of application No. 11/172,230, filed on Jun. 30, 2005.
Application No. 11/172,230 is a continuation-in-part of application No. 11/778,523, filed on Jul. 16, 2007.
Application No. 11/778,523 is a continuation-in-part of application No. 10/968,318, filed on Oct. 18, 2004, now Pat. No. 7,244,322.
Application No. 10/968,318 is a continuation of application No. 10/221,638, filed on Jan. 7, 2003, now Pat. No. 7,147,734.
(60) Provisional application No. 60/188,979, filed on Mar. 13, 2000.

(51) Int. Cl. A47C 23/00; B32B 3/10; B32B 37/14

(52) U.S. Cl. 5/698; 428/138; 156/60

(57) ABSTRACT

A mattress or mattress foundation comprising a core and a ticking surrounding the core, the core comprising a spring assembly, a flammable core component positioned above the spring assembly, and a fire resistant (FR) insulator pad positioned between a spring assembly and the flammable core component, wherein the FR Insulator pads protects the flammable core component by delaying the penetration of the flammable core component by the spring assembly during a partial or complete consumption of the mattress or mattress foundation by a fire. The FR insulation pad may be a nonwoven fiber batt comprising a homogeneous blend of shoddy fibers and oxidized polyacrylonitrile fibers. If the mattress or mattress foundation further comprises a surface FR layer, the surface FR layer is the primary FR layer for the mattress or mattress foundation and the FR Insulator pad is the secondary FR layer for the mattress or mattress foundation.

### CROSS-REFERENCE TO RELATED APPLICATIONS

This application is a Continuation of and claims benefit under 35 USC §120 to co-pending U.S. patent application Ser. No. 11/172,230 entitled “Fire Resistant Insulator Pad” filed Jun. 30, 2005; and this application is also a Continuation-in-Part of and claims benefit under 35 USC § 120 to co-pending U.S. patent application Ser. No. 11/778,523 entitled “Fire Combustion Modified Batt” filed Jul. 16, 2007, which in turn is a Continuation-in-Part of and claims benefit under 35 USC §120 to U.S. Pat. No. 7,244,322 entitled “Method for Forming Fire Combustion Modified Batt” filed Oct. 18, 2004, which is a Continuation of and claims benefit under 35 USC §120 to U.S. Pat. No. 7,147,734 entitled “Method for Forming Fire Combustion Modified Batt” filed Jan. 7, 2003, which is a national stage (continuation) of and claims benefit under 35 USC 371 to International Patent Application PCT/US01/07831 entitled “Method for Forming Fire Combustion Modified Batt” filed Mar. 13, 2001, which is related to and claims benefit under 35 USC §119 to U.S. Provisional Patent Application Ser. No. 60/188,979 entitled “Bi-lofted Fire Combustion Modified Batt” filed Mar. 13, 2000; all of which are assigned to the Assignee of the present application and hereby incorporated by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A mattress typically comprises a mattress core encased in a decorative ticking. The mattress core contains various components such as foam, high-loft and densified nonwoven fiber batts, and springs. The foam and high-loft fiber batts provide softness and comfort for a person sleeping on the mattress, while the springs and densified fiber batts provide firmness and support for the person sleeping on the mattress. In order to keep the springs from penetrating the other layers of the mattress core, a densified fiber batt, known as an insulator pad, is positioned between the springs and the other mattress core components. The insulator pad is sufficiently dense such that it cannot be penetrated by the wire that makes up the mattress springs.

In recognition of the dangers associated with mattress fires, mattress manufacturers have recently begun designing fire resistant (FR) mattresses. Mattress fires are dangerous because the combustible mattress core components (i.e. the foam and fiber batts) burn rapidly when ignited. The heat from the fire also heats the compressed mattress springs, causing them to expand. As the mattress fire consumes the insulator pad, the insulator pad weakens and is unable to maintain the separation between the springs and the other combustible mattress core components. Consequently, the springs penetrate the insulator pad and push the mattress core components into the fire, infusing the fire with fresh fuel. Because the springs are wound in a helical pattern with air in the center, when the springs expand into the fire, they also infuse the fire with fresh oxygen. The combination of flammable fabrics, foams, and compressed mattress springs make mattress fires one of the most dangerous types of household fires. Realizing the magnitude of the danger associated with mattress fires, almost every mattress manufacturer in the United States has developed, or is developing, mattresses incorporating FR materials.

An important part of an FR mattress design is the location of the layer of FR material (the FR layer) within the mattress. Existing FR mattress designs locate the FR layer at or near the surface of the mattress. For example, some products incorporate the FR layer into the mattress ticking, while other products position the FR layer directly underneath the mattress ticking. The fundamental concept behind these products is the creation of a FR layer between the fire and most or all of the combustible mattress components, thereby separating the fire from a potential fuel source.

Locating the FR layer at or near the surface of the mattress limits the effectiveness of the FR layer. Being located at or near the surface of the mattress, the FR layer is limited to soft and flexible materials because the use of hard or rigid materials at or near the surface of the mattress makes the mattress uncomfortable to sleep on. In order for the FR layer to be soft and flexible, however, the structural integrity of the FR layer must be decreased. The decrease in structural integrity makes the FR layer susceptible to fracture or breakage, particularly during a fire. If the FR layer fractures or breaks during a fire, the FR layer is no longer able to maintain the separation between the fire and the combustible mattress core components. Without this separation, the fire consumes the insulator pad and other combustible mattress core components and heats the compressed mattress springs causing them to expand and penetrate the insulator pad, the mattress core components, and the FR layer, further propagating the mattress fire. Thus, the failure of any part of the FR layer eventually leads to propagation of the mattress fire as if there were no FR layer. The FR characteristics of the mattress would be improved if there were a secondary FR layer within the mattress such that failure of a part of the primary surface FR layer would not allow the springs to propagate the fire. Consequently, a need exists for an apparatus that maintains the separation of the mattress springs and the flammable mattress core components during a fire.

### SUMMARY OF THE INVENTION

In one aspect, in invention is an apparatus comprising a core; and a ticking surround the core; the core comprising a spring assembly; a flammable core component positioned above the spring assembly; and a fire resistant (FR) insulator pad positioned between the spring assembly and the flammable core component. In embodiments, the FR insulator pad comprises a plurality of inherently FR fibers, the FR fibers are oxidized polyacrylonitrile, the FR fibers are modacrylic fibers, and/or the FR fibers are non-inherently FR fibers treated with an FR chemical compound. Variously, the weight per unit area in ounces per square foot of the FR insulator pad is greater than twice the thickness in inches of the FR insulator pad and/or the FR insulator pad is comprised of a blend of a plurality of inherently FR fibers and a plurality of shoddy fibers which are not inherently FR. In another embodiment, the invention includes a mattress comprising the aforementioned apparatus.

In another aspect, the invention is a mattress core comprising a spring assembly having an upper surface; a fire resistant (FR) insulator pad having an upper surface and a lower surface, the lower surface of the FR Insulator pad positioned adjacent to the upper surface of the spring assembly; and a cushioning layer having a lower surface positioned adjacent to the upper surface of the FR Insulator pad; wherein the FR Insulator pad protects the cushioning layer by delaying the penetration of the cushioning layer by the spring assembly during a partial or complete consumption of the core by a fire. In an embodiment, the weight per unit area in ounces per square foot of the FR insulator pad is greater than twice the thickness in inches of the FR insulator pad. Variously, the FR Insulator pad comprises a plurality of inherently FR fibers, the FR insulator pad is comprised of a blend of a plurality of inherently FR fibers and a plurality of shoddy fibers which are not inherently FR, the FR fibers are oxidized polyacrylonitrile, the FR fibers are modacrylic fibers, and/or the FR fibers are fibers treated with an FR chemical compound. In another embodiment, the invention includes a mattress comprising the aforementioned apparatus.

In yet another aspect, the invention is a bedding product comprising a core; a ticking enclosing the core; the core comprising a first core component located within the ticking; a second core component located within the ticking, the second core component capable of penetrating the first core component in the absence of an insulator pad therebetween; a fire resistant (FR) barrier located within the ticking, the FR barrier physically isolating the first core component from the second core component by preventing the second core component from penetrating the first core component; wherein the FR barrier delays penetration of the first core component by the second core component during a partial or complete consumption of the bedding product by a fire. In embodiments, the barrier comprises a plurality of inherently FR fibers, the FR fibers are oxidized polyacrylonitrile, the FR fibers are modacrylic fibers, and/or the FR fibers are fibers treated with an FR chemical compound. In embodiments, the barrier is comprised of a blend of a plurality of inherently FR fibers and a plurality of shoddy fibers which are not inherently FR, and/or the invention includes a mattress comprising the aforementioned apparatus. In another mattress embodiment, the weight per unit area in ounces per square foot of the FR barrier is greater than twice the thickness in inches of the FR barrier.

In a final aspect, the invention is a densified nonwoven fiber batt comprising a plurality of shoddy fibers; a plurality of FR fibers blended with the shoddy fibers to form a homogenous fiber blend; and a resin intermixed with the homogenous fiber blend, the resin bonding the shoddy fibers to other shoddy fibers and to the FR fibers, the resin also bonding the FR fibers to other FR fibers and the shoddy fibers; wherein the weight per unit area in ounces per square foot of the nonwoven fiber batt is greater than twice the thickness in inches of the nonwoven fiber batt. In an embodiment, the FR fibers are selected from the group consisting of: oxidized polyacrylonitrile fibers, modacrylic fibers, and fibers treated with an FR chemical compound. In another embodiment, the invention includes a mattress comprising the aforementioned nonwoven fiber batt.

### BRIEF DESCRIPTION OF THE DRAWINGS

For a more complete understanding of the present invention, and for further details and advantages thereof, reference is now made to the accompanying drawings, in which:

FIG. 1 is a perspective view of an embodiment of the FR Insulator Pad;

FIG. 2 is a section view of an example of a mattress incorporating the FR Insulator Pad;

FIG. 3 is a section view of an example of a mattress foundation incorporating the FR Insulator Pad;

FIG. 4 is a block diagram of one method for manufacturing the fiber batt embodiment of the FR Insulator Pad;

FIG. 5 is a plan view of an embodiment of an apparatus for manufacturing the fiber batt embodiment of the FR Insulator Pad in accordance with the method of FIG. 4;

FIG. 6A is a side view of an embodiment of a thermal bonding apparatus used in forming the shoddy batt embodiment of the FR Insulator Pad in accordance with the method of FIG. 4; and

FIG. 6B is a side view of an alternative embodiment of a thermal bonding apparatus used in forming the shoddy batt embodiment of the FR Insulator Pad in accordance with the method of FIG. 4.

### DETAILED DESCRIPTION OF THE INVENTION

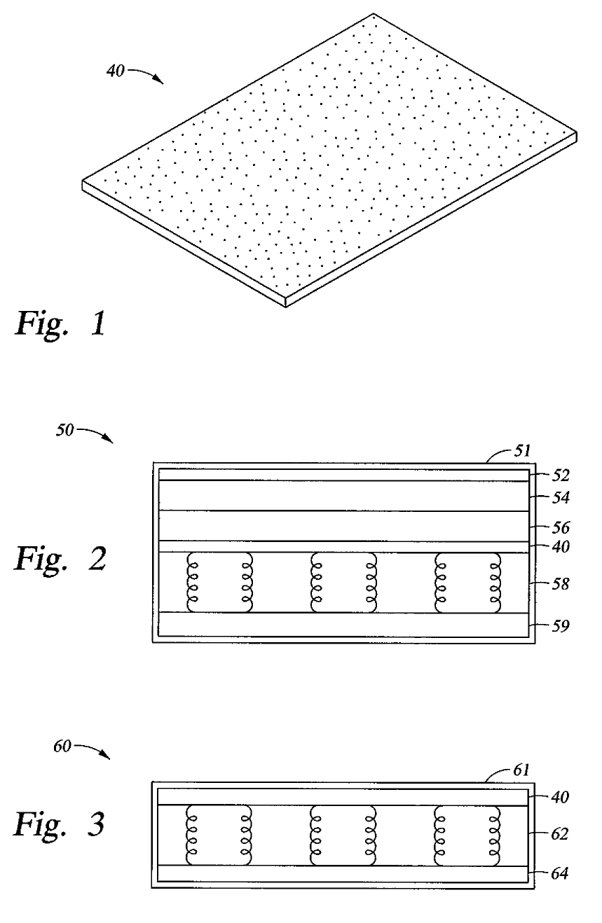

The FR Insulator Pad will now be described in greater detail. As seen in FIG. 1, one embodiment of the FR Insulator Pad 40 is a densified nonwoven fiber batt comprising a plurality of carrier fibers and a plurality of FR fibers. The carrier fibers and the FR fibers are blended together into a homogeneous fiber blend prior to being formed into the FR Insulator Pad 40. While the fiber blend can be any of a number of suitable blends, in one embodiment, the carrier fibers can be anywhere in the range of about 5 percent to about 95 percent by volume of the blend with the FR fibers representing the remaining about 95 percent to about 5 percent by volume of the fiber blend. In a preferred embodiment, the fiber blend comprises about 50 percent by volume carrier fibers and about 50 percent by volume of FR fibers. However, the FR Insulator Pad 40 includes numerous possible fiber blend compositions and should not be limited by the specific embodiments discussed herein.

The carrier fibers are fibers that are not inherently FR nor have been treated to become FR. The carrier fibers may be natural fibers, such as cotton, silk, or wool, synthetic fibers, such as rayon, polyester, polypropylene, polyethylene, and other polymer fibers, recycled fibers, such as shoddy fibers, or combinations thereof. Preferably, the carrier fibers are shoddy fibers, which are fibers recycled from clothing, bedding, fabric, and other natural and synthetic materials. Alternatively, the shoddy materials may be a specific type of recycled fiber, such as polyester or polypropylene from the manufacturing of bedding components or cotton waste from the yarn spinning process. The shoddy material is generally cleaned and shredded to form a homogeneous fiber blend prior to being blended with the FR fibers.

The FR fibers are fibers that resist burning, impede the propagation of a fire, reduce the ignitability of the volatile gases produced during burning, and/or help to extinguish the fire. The FR fibers may be fibers that are inherently FR, such as charring fibers, or fibers that have been chemically treated to become FR, such as fibers treated with a FR chemical compound. Examples of FR fibers are fully or partially oxidized polyacrylonitriles (O-PAN) such as PYRON® available from Zoltek, FORTAFIL® available from Fortafil Fibers, AVOX™ available from Textron, PANOX available from SGL Technik, THORNEL® available from Amoco Performance Products, and PYROMEX® available from Toho Texax; meta-aramids, such as NOMEX® available from DuPont, TEUINCONEX™ available from Teijin Limited, and FENYLENE™ available from Russian State Complex, including poly(m-phenylene isophthalamide); para-aramids such as KEVLAR® available from DuPont, TECHNORA® available from Teijin Limited, TWARON® available from Teijin Twaron, and FENYLENE™ available from the Russian State Complex, including poly(p-phenylene terephthalamide) and poly(diphenylether para-aramid); melamines such as BASOFIL® available from Basofil Fibers; polybenzimidazole; poly (p-phenylene benzobisoxazoles); polyctherimides; polybenzimidazole such as PBI® by Hoechst Celanese; polyimides such as P-84™ by Inspec Fibers and KAPTON® by DuPont; polyamideimides such as KERMEL® by Kermel; novoloids such as phenol-formaldehyde novolac and KYNOL™ available from Gun Ei Chemical Industry; poly (p-phenylene benzobisoxazole) (PBO) such as ZYLON® available from Toyobo; poly (p-phenylene benzothiazoles) (PBT); polyphenylene sulfide (PPS) such as RYTO® available from Chevron Phillips Chemical, TORAY PPS available from Toray Industries, FORTRON® available from Hoechst Celanese, and PROCON™ available from Toyobo; flame retardant viscose rayons, such as LENZING® FR by Lenzing and VISIL® by Steri Oy; polyetheretherketones (PEEK) such as ZYEX® available from Zyex Ltd.; polyketones (PEK) such as ULTRAPEK™ available from BASF; polyetherimides (PEI) such as ULTEM® available from General Electric; and combinations thereof.

FR fibers may also be fibers that release oxygen depleting gasses to substantially reduce or eliminate the ignitability of the volatile gases produced during burning and help to extinguish the fire. Examples of these FR fibers are: chloropolymeric fibers, such as those containing polyvinyl chloride (PVC) or polyvinylidene homopolymers and copolymers, such as THERMOVYL™, FIBRAVYL™, RETRACTYL™, and ISOVYL™ available from Rhovyl; PIVIACID™ available from Thueringische; VICLON™ available from Kureha Chemical Industry, TEVIRON® available from Teijin Ltd., ENVILON® available from Toyo Chemical, and VICRON™ made in Korea; SARAN™ available from Pittsfield Weaving, KREHALON™ available from Kureha Chemical Industry, and OMNI-SARAN™ available from Fibrasomni; and modacrylics which are vinyl chloride or vinylidene chloride copolymer variants of acrylonitrile fibers, such as PROTEX® available from Kanegafuchi Chemical and SEF® available from Solutia; and combinations thereof. Further examples of these FR fibers are Fluoropolymeric fibers such as polytetrafluoroethylene (PTFE), such as TEFLON® available from DuPont, LENZING™ available from Lenzing, RASTEX® available from W. R. Gore and Associates, GORE-TEX™ available from W. R. Gore and Associates, PROFILEN® available from Lenzing, and TOYOFLON® available from Toray Industries; poly(ethylene-chlorotrifluoroethylene) (E-CTFE) such as HALAR® available from Ausimont and TOYOFLON® available from Toray Industries, polyvinylidene fluoride (PVDF) such as KYNAR® available from Arkema, and FLORLON™ available from Russian State Complex; polyperfluoroalkoxy (PFA) such as TEFLON® available from DuPont and TOYOFLON® available from Toray Industries, polyfluorinated ethylene-propylene (FEP) such as TEFLON® FEP available from DuPont; and combinations thereof.

An example of a mattress incorporating the FR Insulator Pad 40 is shown in FIG. 2. The design and construction of individual mattresses may vary from the example shown in FIG. 2. The mattress 50 comprises a ticking 51 that surrounds a mattress core made up of a pillow top 52, comfort layers 54 and 56, the FR Insulator Pad 40, spring assembly 58, and stabilizing layer 59. The ticking 51 is a decorative fabric that surrounds the mattress core. The pillow top 52 is low density foam or a high-loft nonwoven fiber batt. The comfort layers 54 and 56 are foam or nonwoven fiber batts of various densities. The stabilizing layer 59 is high density foam or a densified nonwoven fiber batt. The spring assembly 58 includes at least one coiled metal wire, most commonly, a compression spring, although other types of springs may be suitable for the purposes contemplated herein, which support the weight of a person sleeping on the mattress. Variously, the plural springs may be unconnected springs residing in a common space and configured for independent movement relative to one another, coupled to another by an interconnecting frame (not shown) and configured for independent movement relative to one another, or coupled to one another by the interconnecting frame and configured for common movement. It is further contemplated that the common space of the spring assembly may be filled with air, loose fibers (also known as fiberfill), fiber batts, or other materials. If material is used to fill the common space, such material may either be flammable or FR. The FR Insulator Pad 40 is positioned adjacent to the upper surface of the spring assembly 58, between the spring assembly 58 and the combustible mattress core components, which in the example provided herein are comprised of the pillow top 52 and the comfort layers 54 and 56. If desired, a second FR Insulator Pad 40 may be positioned adjacent to the lower surface of the spring assembly 58, between the spring assembly 58 and the stabilizing layer 59. The incorporation of the second FR insulator pad would be advantageous in a mattress design that includes additional combustible mattress core components on the lower side of the spring assembly 58 such that mattress has a mirrored configuration from top to bottom. Such mattresses are considered “flipable” in that they provide the same amount of support to the user regardless of the side of the mattress that the user sleeps on. In either case, the FR Insulator Pad 40 is sufficiently dense to prevent a wire from a spring forming part of the spring assembly 58 from penetrating the FR Insulator Pad 40 and one or more of the combustible mattress core components 52, 54, and 56, all of which are more susceptible to penetration that the FR Insulator Pad 40.

An example of a mattress foundation incorporating the FR Insulator Pad 40 is shown in FIG. 3. The design and construction of individual mattress foundations may vary from the example shown in FIG. 3. In a typical configuration, the mattress 50 sits atop the mattress foundation 60. The mattress foundation 60 comprises a ticking 61 that surrounds a mattress foundation core made up of the FR Insulator Pad 40, spring assembly 62, and a frame 64. The ticking 61 is a decorative fabric that surrounds the mattress foundation core. All or part of the mattress foundation 60 may contain mesh netting in lieu of the ticking 61. The spring assembly 62 includes one or more coiled metal wires, most commonly, compression springs that support the weight of the mattress. The frame 64 is a supporting structure for the spring assembly 62 and is typically made of wood. The FR Insulator Pad 40 is positioned adjacent to the upper surface of the spring assembly 62 between the spring assembly 62 and the ticking 61. The FR Insulator Pad 40 is sufficiently dense to prevent a wire from a spring forming part of the spring assembly 62 from penetrating the FR Insulator Pad 40.

The advantageous properties of the FR Insulator Pad 40 are evident when the mattress 50 or mattress foundation 60 ignites. The function served by conventionally configured insulator pads is to prevent the springs of the spring assembly located on one side of the insulator pad from penetrating through the foam, non-woven fiber batt and/or quilted fiber layers positioned on the other side of the insulator pad. Under normal conditions, a conventionally configured insulator pad would have a sufficient level of mechanical integrity to prevent various components of the spring assembly from penetrating the other layers of the mattress. However, the mechanical integrity of the insulator pad seriously degrades upon the application of flame thereto. Upon loss of mechanical integrity resulting from the combustion of the insulator pad, various components of the spring assembly penetrate through the other layers of the mattress, thereby directly exposing both additional portions of the foam, non-woven fiber batt and/or quilted fiber layers, as well as any combustibles located within the combustible mattress core components 52, 54, and 56, to the flame. In contrast, by using, in accordance with the technology of the present invention, a highly densified FR nonwoven fiber batt to form the FR Insulator Pad 40, the FR characteristic of the FR Insulator Pad 40 is enhanced relative to that of a conventionally configured insulator pads. As a result, the mechanical integrity of the FR Insulator Pad 40 produced by the use of a highly densified FR nonwoven fiber batt resists weakening upon the application of a flame thereto, thereby preventing or, at a minimum, significantly delaying penetration of the spring assembly through the flammable layers of the mattress which overlie the FR Insulator Pad 40.

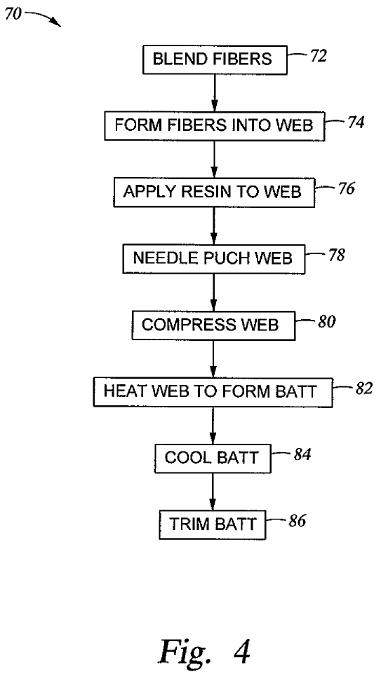

One method for making the FR Insulator Pad will now be described in greater detail. As seen in FIG. 4, a method 70 for making the nonwoven fiber batt embodiment of the FR Insulator Pad commences at step 72 when the carrier fibers and FR fibers are blended to form a homogeneous fiber blend. Proceeding on to step 74, a web is formed from the fibers of the homogeneous fiber blend. At step 76, the web is coated with a resin, and then the web is subsequently needle punched at step 78. The web is then compressed in step 80 and heated in step 82 to form a nonwoven fiber batt. The nonwoven fiber batt is subsequently cooled at step 84 and trimmed at step 86, thereby forming the FR Insulator Pad 40 shown in FIG. 1. Each of these steps is described in greater detail below.

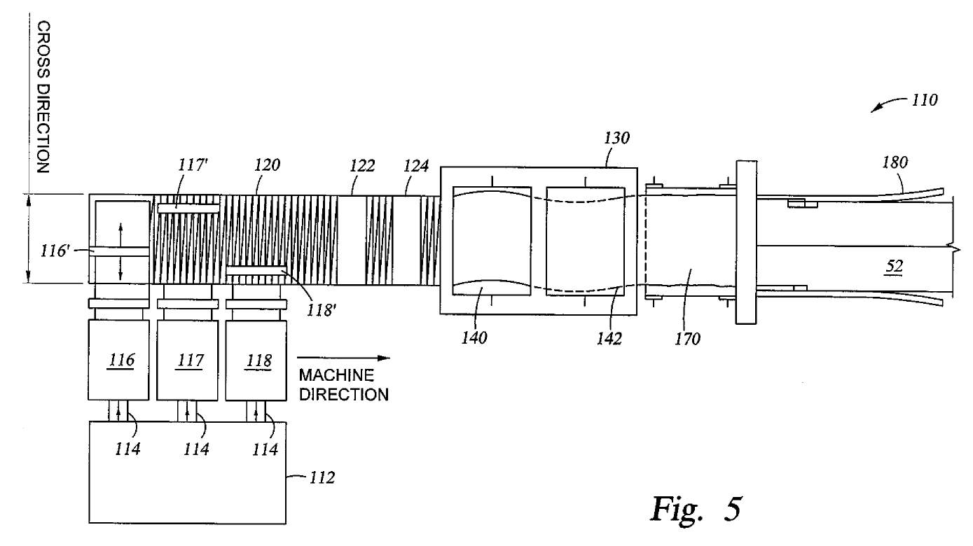

Referring now to FIG. 5, a schematic top plan view of the general processing line 110 for constructing an FR Insulator Pad 40 in accordance with the teachings of the present invention will now be described in greater detail. The general processing line performs steps 72 through 86 of method 70. As may now be seen, the carrier fibers and FR fibers are blended together per step 72 of method 70 in a fiber blender 112 and conveyed by conveyor pipes 114 to a web forming machine or, in this example, three machines 116, 117, and 118. The fibers are preferably a blend of charring fibers, such as O-PAN, and shoddy fibers but may be a blend of any FR fiber and any carrier fiber. A suitable web forming apparatus is a garnett machine. An air laying machine, known in the trade as a Rando webber, or any other suitable apparatus can also be used to form a web structure. Garnett machines 116, 117, and 118 card the blended fibers into a web per step 74 of method 70, and deliver the web to cross-lappers 116′, 117′, and 118′ to cross-lap the web onto a slat conveyor 120 moving in the machine direction. Cross-lappers 116′, 117′, and 118′ reciprocate back and forth in the cross direction from one side of conveyor 120 to the other side to form a web having multiple thicknesses in a progressive overlapping relationship. The number of layers that make up the web is determined by the speed of the conveyor 120 in relation to the speed at which successive layers of the web are layered on top of each other and the number of cross-lappers 116′, 117′, and 118′. Thus, the number of single layers which make up the web can be increased by slowing the relative speed of the conveyor 120 in relation to the speed at which cross layers are layered, by increasing the number of cross-lappers 116′, 117′, and 118′, or both. Conversely, a fewer number of single layers can be achieved by increasing the relative speed of conveyor 120 to the speed of laying the cross layers, by decreasing the number of cross-lappers 116′, 117′, and 118′, or both. In the present invention, the number of single layers which make up the web of fibers vary depending on the desired fire resistance, density, and thickness of the FR Insulator Pad 40 of the present invention. As a result, the relative speed of the conveyor 120 to the speed at which cross layers are layered and the number of cross-lappers 116′, 117′, and 118′ for forming the web may vary accordingly.

A heat curable resin is then applied to the web by resin applicator 122 per step 76 of method 70. There are a variety of techniques suitable for applying resins onto the web. For example, liquid resin may be sprayed or froth resin extruded onto the web. Resins suitable for the present invention are curable by heat and can be any of a variety of compositions. Generally, the resin is comprised of polyvinyl acetate but may also be a polymeric composition such as vinylidene chloride copolymer, latex, acrylic, or any other chemical compound. An example of a suitable resin is the SARAN™ 506 resin available from the Dow Chemical Company. Additionally, the resin can contain antimicrobial, antifungal, or hydrophobic additives that further enhance the properties of the FR Insulator Pad 40.

Further describing the application of liquid resin, as the web moves along a conveyor in the machine direction, the resin is sprayed onto the web from one or more spray heads that move in a transverse or cross direction to substantially coat the web. Alternatively, froth resin can be extruded onto the web using a knife or other means. The web can also be fed through or dipped into a resin bath. The applied resin is crushed into the web for saturation therethrough by nip rollers disposed along the transverse direction of the conveyor to apply pressure to the surface of the batt. Alternatively, the resin is crushed into the web by vacuum pressure applied through the batt.

The web then moves to a needle loom 124 where the web is needle-punched per step 78 of method 70 to increase the density of the web. The needle loom 124 is a device that bonds a nonwoven web by mechanically entangling the fibers within the web. The needle loom 124 contains a needle board (not shown) that contains a plurality of downwardly-facing barbed needles arranged in a non-aligned pattern. The barbs on the needles are arranged such that they capture fibers when the needle is pressed into the web, but do not capture any fibers when the needle is removed from the web. A variety of suitable needles are available from the Foster Needle Company. The use of the needle loom in the present invention provides mechanical compression of the web prior to the application of heat in combination with either vacuum and/or mechanical compression within housing 130. Of course, it is within the scope of the invention to forego the needle punching step described herein if adequate compression can be obtained by vacuum and/or mechanical compression. Likewise, it is within the scope of the invention to forego the vacuum and/or mechanical compression steps if adequate compression can be obtained by needle punching.

The conveyor 120 then transports the web to housing 130 for mechanical and/or vacuum compression per step 80 of method 70 and heating per step 82 of method 70. While there are a variety of resin bonding methods which are suitable for the purposes contemplated herein, one such method the application of vacuum pressure through perforations (not shown) in first and second counter rotating drums 140 and 142 positioned in a central portion of the housing 130. The first and second counter rotating drums 140 and 142 heat the web to the extent necessary to cure the resin in the web. For example, heating the web to a temperature of 225-275° F. for a period of three to five minutes is suitable for the purposes contemplated herein. Alternatively, the web may instead move through an oven by substantially parallel perforated or mesh wire aprons that mechanically compress the batt and simultaneously cure the resin.

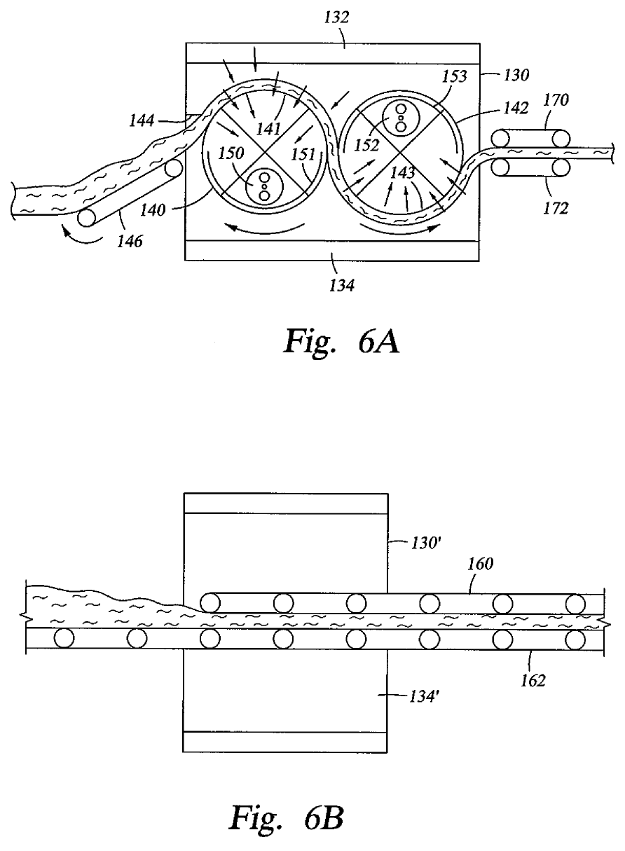

As the web exits the housing 130, the web is compressed and cooled per step 84 of method 70 using a pair of substantially parallel wire mesh aprons 170, only one of which is visible in FIG. 5. The aprons 170 are mounted for parallel movement relative to each other to facilitate adjustment for a wide range of web thicknesses. The web can be cooled slowly through exposure to ambient temperature air or, in the alternative, ambient temperature air can be forced through the perforations of one apron 170, through the web and through the perforations of the other apron 172 from FIG. 6A to cool the web and set it in its compressed state. The web is maintained in its compressed form upon cooling since the solidification of the resin bonds the fibers together in that state.

While there are a variety of resin bonding methods which are suitable for the present invention, one such method, illustrated in FIG. 6A, comprises holding the web by vacuum pressure applied through perforations of first and second counter-rotating drums and heating the web so that the resin in the batt cures to the extent necessary to fuse together the fibers in the web. Alternatively, the web moves through an oven by substantially parallel perforated or mesh wire aprons to cure the resin.

As may be seen in FIG. 6A, the aforementioned vacuum pressure method may be implemented using counter-rotating drums 140, 142 having perforations 141, 143, respectively, which are positioned in a central portion of a housing 130. The housing 130 also comprises an air circulation chamber 132 and a furnace 134 in an upper portion and a lower portion, respectively, thereof. The drum 140 is positioned adjacent an inlet 144 though which the web is fed. The web is delivered from the blending and web-forming processes described herein by means of an infeed apron 146. A suction fan 150 is positioned in communication with the interior of the drum 140. The lower portion of the circumference of the drum 140 is shielded by a baffle 151 positioned inside the drum 140 such that the suction-creating air flow is forced to enter the drum 140 through the perforations 141, which are proximate the upper portion of the drum 140, as the drum 140 rotates.

The drum 142 is downstream from the drum 140 in the housing 130. The drums 140, 142 can be mounted for lateral sliding movement relative to one another to facilitate adjustment for a wide range of batt thicknesses (not shown). The drum 142 includes a suction fan 152 that is positioned in communication with the interior of the drum 142. The upper portion of the circumference of the drum 142 is shielded by a baffle 153 positioned inside the drum 142 so that the suction-creating air flow is forced to enter the drum 142 through the perforations 143, which are proximate the lower portion of drum 142, as the drum 142 rotates.

The nonwoven web is held in vacuum pressure as it moves from the upper portion of the rotating drum 140 to the lower portion of the counter rotating drum 142. The furnace 134 heats the air in the housing 130 as it flows from the perforations 141, 143 to the interior of the drums 140, 142, respectively, to cure the resin in the web to the extent necessary to bind together the fibers in the web.

Referring to FIG. 6B, in an alternative resin bonding process, the web enters housing 130′ by a pair of substantially parallel perforated or mesh wire aprons 160, 162. The housing 130′ comprises an oven 134′ that heats the web to cure the resin to the extent necessary to bind the fibers in the web together.

Collectively referring back to FIGS. 4, 5, 6A and 6B, the web is compressed and cooled per step 84 of method 70 as it exits from the housing 130 or 130′ by a pair of substantially parallel first and second perforated or wire mesh aprons 170 and 172 or 160 and 162. The aprons 170 and 172 or 160 and 162 are mounted for parallel movement relative to each other to facilitate adjustment for a wide range of web thicknesses (not shown). The web can be cooled slowly through exposure to ambient temperature air or, alternatively, ambient temperature air can be forced through the perforations of one apron, through the web and through the perforations of the other apron to cool the web and set it in its compressed state. The web is maintained in its compressed form upon cooling since the resin bonds the fibers together in the compressed state. The cooled web (which, after completion of the bonding, compression and cooling steps, is referred to as a batt) moves into cutting zone 180 where the lateral edges of the batt are trimmed per step 86 of method 70 to a finished width. The batt is then cut transversely to a desired length to form the FR Insulator Pad 40.

It is contemplated that other bonding methods, such as mechanical bonding and thermal bonding, may be used to bond the batt together in lieu of the resin bonding method described herein. Mechanical bonding is the process of bonding the nonwoven batt together without the use of resins, adhesives, or heat. Examples of mechanical bonding methods are needle punching and hydro entanglement. Needle punching is the previously described method of entangling fibers using barbed needles. Hydro entanglement uses streams of high pressure water to entangle the fibers of the nonwoven web. Thermal bonding uses low-melt binder fibers to bind the fibers together. Low-melt binding fibers do not actually melt as the term is generally understood; instead, the low-melt binder fibers become sticky or tacky when heated to a certain temperature. If the fiber batt is to be thermally bonded, the low-melt binder fibers are blended with the carrier fibers and FR fibers to make a homogeneous fiber blend of carrier fibers, FR fibers, and low-melt binder fibers. The fiber blend is then carded into a web as described above. There is no need to apply a resin to the web if the web is to be thermally bonded. The web is then needle punched, if a compression step is desired prior to simultaneous heat and compression. The web is then sent to a compression and heating apparatus, such as those illustrated in FIGS. 6A and 6B, where the heat melts the low-melt binder fibers rather than curing the resin. The batt is then cooled and trimmed in the same way that the resin embodiment of the batt was cooled and trimmed. The FR Insulator Pad 40 includes nonwoven production methods other than the nonwoven production methods described herein and should not be limited to the nonwoven production methods described herein.

In the embodiment utilizing a nonwoven fiber batt as the FR Insulator Pad 40, the weight, density, and thickness of the FR Insulator Pad are determined by, among other factors, the process of compressing the batt as it is cooled. The ratio of batt density to batt thickness generally dictates whether the FR Insulator Pad 40 is a high loft batt or a densified batt. For purposes herein, a densified energy absorbing layer has a ratio of weight (in ounces) per square foot to thickness (in inches) greater than about 2 to 1. For example, a fiber batt that is one foot wide, one foot long, one inch thick and has a weight of three ounces is defined herein as a densified fiber batt. In an embodiment, such densified FR Insulator Pads 40 has a density greater than about 1.5 pounds per cubic foot (pcf). Conversely, an FR Insulator Pad 40 having a ratio of weight to thickness of less than about 2 to 1 and/or a density less than about 1.5 pcf are defined herein as high loft batts. For example, a fiber batt that is one foot wide, one foot long, one inch thick and has a weight of one ounce is defined herein as a high loft fiber batt.

The FR Insulator Pad 40 may also be used for may other applications. For example, the FR Insulator Pad 40 may be incorporated into residential or commercial furniture to maintain the separation between the furniture spring assembly and the other furniture components. The FR Insulator Pad 40 may also be incorporated into vehicle or aircraft seats to maintain the separation between the seat spring assembly and the other seat components.

While a number of preferred embodiments of the invention have been shown and described herein, modifications thereof may be made by one skilled in the art without departing from the spirit and the teachings of the invention. The embodiments described herein are exemplary only, and are not intended to be limiting. Many variations, combinations, and modifications of the invention disclosed herein are possible and are within the scope of the invention. Accordingly, the scope of protection is not limited by the description set out above, but is defined by the claims which follow, that scope including all equivalents of the subject matter of the claims.

1. A mattress core comprising:
a spring assembly having an upper surface;
a fire resistant (FR) insulator pad having an upper surface and a lower surface, the lower surface of the FR insulator pad positioned adjacent to the upper surface of the spring assembly; and
a cushioning layer having a lower surface positioned adjacent to the upper surface of the FR Insulator pad;
wherein the FR insulator pad comprises a plurality of fibers and a resin intermixed with the fibers, the resin bonding the fibers to other of the plurality of fibers.

2. The core of claim 1 wherein the weight per unit area in ounces per square foot of the FR insulator pad is greater than twice the thickness in inches of the FR insulator pad.

3. The core of claim 1 wherein the resin provides FR characteristic to the FR insulator pad.

4. The core of claim 3 wherein the plurality of fibers comprise shoddy fibers.

5. The core of claim 1 wherein the plurality of fibers comprise FR fibers.

6. The core of claim 5 wherein the FR fibers comprise inherently FR fibers.

7. The core of claim 6 wherein the inherently FR fibers are oxidized polyacrylonitrile.

8. The core of claim 6 wherein the inherently FR fibers are modacrylic fibers.

9. The core of claim 5 wherein the FR fibers are fibers treated with an FR chemical compound.

10. An FR insulator pad comprising:
a plurality of shoddy fibers; and
a resin having FR characteristics intermixed with the plurality of shoddy fibers, the resin bonding the shoddy fibers to other shoddy fibers.

11. The FR insulator pad of claim 10 wherein the weight per unit area in ounces per square foot of the FR insulator pad is greater than twice the thickness in inches of the FR insulator pad.

12. The FR insulator pad of claim 10 further comprising FR fibers.

13. The FR insulator pad of claim 12 wherein the FR fibers are inherently FR fibers.

14. The FR insulator pad of claim 12 wherein the FR fibers are non-inherently FR fibers each treated over substantially their entire surface with an FR chemical compound.

15. The FR insulator pad of claim 12 wherein the shoddy fibers and the FR fibers are substantially homogenously blended to provide substantially uniform FR characteristic throughout the FR insulator pad.

16. An apparatus comprising:
a core; and
a ticking surround the core;
the core comprising:
a spring assembly;
a flammable core component positioned above the spring assembly; and
a fire resistant (FR) insulator pad positioned between the spring assembly and the flammable core component.

17. The apparatus of claim 16 wherein the FR insulator pad comprises a plurality of inherently FR fibers.

18. The apparatus of claim 16 wherein the FR insulator pad comprises a plurality of FR fibers, wherein the FR fibers are non-inherently FR fibers treated with an FR chemical compound.

19. The apparatus of claim 16 wherein the weight per unit area in ounces per square foot of the FR insulator pad is greater than twice the thickness in inches of the FR insulator pad.

20. The apparatus of claim 16 wherein the FR insulator pad is comprised of a homogeneous blend of a plurality of FR fibers and a plurality of shoddy fibers which are not inherently FR.

21. The apparatus of claim 16 wherein the FR insulator pad comprises a plurality of shoddy fibers and a resin having FR characteristics intermixed with the plurality of shoddy fibers, the resin bonding the shoddy fibers to other shoddy fibers.

22. A method of forming a mattress core comprising:
providing an FR insulator pad, a spring assembly, and a flammable core component; and
positioning the FR insulator pad between the spring assembly and the flammable core component.

23. The method of claim 22 further comprising forming the FR insulator pad, wherein forming the FR insulator pad comprises:
forming a web from a plurality of fibers; and
applying a resin to the web, the resin bonding fibers to other of the plurality of fibers and the resin having FR characteristics.

24. The method of claim 23 wherein the plurality of fibers are shoddy fibers.

25. The method of claim 22 further comprising forming the FR insulator pad, wherein forming the FR insulator pad comprises substantially homogeneously blending FR fibers with carrier fibers.

26. The method of claim 23 wherein forming the FR insulator pad further comprises needle-punching the web.
